(19) United States
(12) Patent Application Publication
(10) Pub. No.: US 2024/0042303 A1
(43) Pub. Date: Feb. 8, 2024

(54) Equipment With Real-Time Interactive Function and Using Method Thereof

(71) Applicant: OHFG TECHNOLOGIES (SHANGHAI) CO., LTD., Shanghai (CN)

(72) Inventor: Ping LIU, Shanghai (CN)

(73) Assignee: OHFG TECHNOLOGIES (SHANGHAI) CO., LTD., Shanghai (CN)

(21) Appl. No.: 17/640,344

(22) PCT Filed: Jul. 22, 2021
(86) PCT No.: PCT/CN2021/107758

§ 371 Date: Jan. 19, 2023

(30) Foreign Application Priority Data
Jul. 13, 2021 (CN) 202110787331.4

(51) Int. Cl. A63B 71/06; A63B 24/00

(52) U.S. Cl. CPC A63B 71/0622; A63B 24/0006; A63B 24/0062; A63B 2024/0009; A63B 2225/20; A63B 2225/50

(57) ABSTRACT

The present invention discloses equipment with real-time interactive function and a using method thereof. The equipment is provided with an interactive connection system; an external terminal is connected to the equipment via the interactive connection system, and can directly control the external terminal to open a designated software interface, or directly enables the external terminal to realize a Bluetooth automatic pairing connection with the equipment, thereby reducing the cumbersome procedure of manually opening an APP and the cumbersome procedure of manually connecting the Bluetooth, and saving time, making it convenient and quick. Furthermore, the movement information on the equipment can be obtained through the above-mentioned connection and interaction, and the relevant information can be obtained through a simple and quick connection for subsequent information processing and displaying. By displaying via the connecting software, the relevant information about the exercise using the equipment is displayed to the body builder, so as to facilitate the body builder to have a clearer understanding of the movement status, and facilitate the body builder to arrange the fitness through statistical induction and summary.

### TECHNICAL FIELD

The present invention relates to the field of fitness facility, and more particularly to equipment with real-time interactive function and a using method thereof.

### BACKGROUND ART

Equipment is often divided into two categories of single function and comprehensive multi-function according to the number of training functions. The commonly used equipment is a rowing device, a bodybuilding vehicle, a striding machine, a running machine, a waist machine, etc. With the acceleration of urban life rhythm and the increase of working pressure, the number of urban residents in sub-health status in China is more and more. More and more people will choose bodybuilding and other sports to relieve the pressure and work out. With the progress of science and technology and social and economic development, people put forward higher requirements for equipment.

In order to facilitate a body builder to know his own exercise conditions, there appears a lot of equipment on the market that can record the exercise conditions in real time. The general principle for the equipment to realize the detection and recording of the amount of exercise is as follows: the relevant data is collected by sensors and other collection devices, and then processed and displayed by the equipment's screen computer. The body builder can know his/her own exercise conditions through observing the screen. This kind of equipment can only display the body builder's exercise conditions, and can not realize the statistical summary of the exercise conditions. It is inconvenient for the body builder to arrange the workout. At the same time, it is inconvenient for a fitness center to perform scientific statistical analysis on the body builder. There are some defects.

### SUMMARY OF THE INVENTION

It is an object of the present invention to provide equipment with real-time interactive function and a using method thereof so as to realize the interaction between the equipment and a mobile phone of a body builder, thereby facilitating the body builder to perform fitness arrangement and facilitating a fitness center to perform scientific statistical analysis on the body builder.

In order to solve the above technical problem, the present invention provides equipment with real-time interactive function, comprising: equipment and an interactive connection system, wherein the interactive connection system is arranged on the equipment, and an external terminal is connected to the equipment via the interactive connection system.

The equipment is body-building equipment, such as running machine, mountain climbing machine, rowing machine, etc., and can also be rehabilitation equipment, sports equipment, or training equipment, etc.

Further, according to the equipment with real-time interactive function, the external terminal approaches or nears the interactive connection system on the equipment to realize a near-field connection.

Further, according to the equipment with real-time interactive function, the near-field connection is realized via NFC.

Further, according to the equipment with real-time interactive function, the external terminal is remotely connected to the interactive connection system on the equipment via connecting software.

Further, according to the equipment with real-time interactive function, a remote connection is realized by Bluetooth, mobile communication, WiFi, or infrared communication.

According to another aspect of the present invention, another equipment with real-time interactive function is further proposed, comprising: equipment main body for realizing an interactive connection system for an interactive function between the equipment main body and an external terminal, wherein the interactive connection system comprises a hardware subsystem and a software subsystem installed on the equipment, the hardware subsystem is used for realizing a signal intercommunication connection between the external terminal equipment main body, and the software subsystem is used for processing and sending information about the equipment main body received by the external terminal.

Further, according to the equipment with real-time interactive function, the hardware subsystem comprises a control processing module and an NFC module, wherein the control processing module processes and sends movement data collected by the equipment main body, and sends an instruction, the NFC module is used for realizing the interactive connection between the control processing module and the external terminal, the control processing module is electrically signal connected to the NFC module, the control processing module is also electrically signal connected to an interface set, and the interface set is installed on the equipment via a switching assembly.

Further, according to the equipment with real-time interactive function, the control processing module comprises a data collection unit, an instruction generation unit, and an information processing unit, wherein the data collection unit is used for collecting the movement data when a user is using the equipment, the instruction generation unit generates a corresponding instruction according to the interactive connection with the external terminal, and the information processing unit is used for sending after processing the movement data collected by the equipment and a control instruction generated by the instruction generation unit.

Further, according to the equipment with real-time interactive function, the interface set includes a Lightning interface, a Type-c interface, and a Micro-usb interface.

Further, according to the equipment with real-time interactive function, the equipment main body is provided with an object placing plate, a surface thereof being provided with a screen or a sticker.

In addition, the present invention also provides a using method for equipment with real-time interactive function, wherein when an external terminal approaches an interactive connection system of the equipment, the interactive connection system communicates with the external terminal and directly controls the external terminal to open a designated software interface.

In addition, the present invention also proposes a using method for equipment with real-time interactive function. When an external terminal approaches an interactive connection system of the equipment, the interactive connection system communicates with the external terminal, and directly enables the external terminal to realize a Bluetooth automatic pairing connection with the equipment.

Further, when an external terminal approaches an interactive connection system of the equipment, the interactive connection system communicates with the external terminal, and judges whether the external terminal is installed with connecting software corresponding thereto; if not, the external terminal is enabled to display installation reminding information; if so, the external terminal is directly controlled to open a designated software interface, and the interactive connection system subsequently sends information to the connecting software to display corresponding contents.

Compared with the prior art, the beneficial effects of the present invention are mainly represented as follows: the equipment is provided with an interactive connection system; the external terminal can be connected to the equipment via the interactive connection system, and directly controls the external terminal to open a designated software interface, or directly enables the external terminal to realize a Bluetooth automatic pairing connection with the equipment, thereby reducing the cumbersome procedure of manually opening an APP and the cumbersome procedure of manually connecting Bluetooth, and saving time, making it convenient and quick.

Furthermore, the movement information on the equipment can be obtained through the above-mentioned connection and interaction, and the relevant information can be obtained through a simple and quick connection for subsequent information processing and displaying.

The interactive connection system includes a hardware subsystem and a software subsystem.

The external terminal can realize the near-field connection through NFC, and can also realize the remote connection through the connecting software installed by the external terminal.

After the external terminal is connected with the interactive connection system, the interactive connection system can send the collected equipment movement information to the external terminal, and display the same via the connecting software, so as to display relevant information about the exercise using the equipment to the body builder to facilitate the body builder to have a clearer understanding of the movement status thereof, and facilitate the body builder to arrange for fitness via statistical induction and summary.

### BRIEF DESCRIPTION OF THE DRAWINGS

FIG. 1 is a schematic view of a structure of equipment with real-time interactive function according to the present invention;

FIG. 2 is a schematic view showing a structure of an object placing plate according to the present invention.

### DETAILED DESCRIPTION OF THE INVENTION

The equipment with real-time interactive function of the present invention will be described below in more detail with reference to the schematic drawings wherein preferred embodiments of the present invention are shown. It should be understood that one skilled in the art can modify the invention described herein while still achieving the beneficial effects of the present invention. Accordingly, the following description should be construed as being broadly known by those skilled in the art, and not as a limitation on the present invention.

The present invention is described in more detail in the following paragraphs by way of example with reference to the accompanying drawings. The advantages and features of the present invention will become apparent from the following description and claims. It is noted that the drawings are in very simplified form and are not to scale, and are intended merely to facilitate and clarify the description of the embodiments of the present invention in an auxiliary way.

### Embodiment 1

In this embodiment, there is provided equipment with real-time interactive function, comprising: equipment and an interactive connection system. The interactive connection system is arranged on the equipment, and an external terminal is connected to the equipment via the interactive connection system.

The equipment is body-building equipment, such as running machine, mountain climbing machine, rowing machine, etc., and can also be rehabilitation equipment, sports equipment, or training equipment, etc. in which the equipment is used for human training or rehabilitation, etc.

The external terminal approaches or nears the interactive connection system on the equipment to realize a near-field connection. The external terminal can be a mobile phone, a tablet computer, a bracelet, an intelligent watch, or other intelligent terminals which can realize the connection and data display. The external terminal may connect to the interactive connection system on the equipment via NFC. When the external terminal is installed with connecting software that matches the equipment, the external terminal can remotely connect with the interactive connection system on the equipment via the connecting software. The remote connection is realized by Bluetooth, and mobile communication such as 2G, 3G, 4G, 5G, etc., WiFi or infrared communication.

In addition, the above-mentioned interaction can be used for displaying the movement data of the equipment on an external terminal for reference via the interaction; the external terminal can also send an operation instruction to the equipment through the above-mentioned interactive connection system for operating the equipment; when the equipment comprises an audio and video playing device, the external terminal can play video and audio stored therein on the equipment, etc.

It will be appreciated by those skilled in the art that the interactive connection system on the equipment may be powered by an external power source on the equipment itself to provide the power source for interaction. If the external terminal only needs to be connected and does not need to perform data communication and interaction, the interactive connection system on the equipment can be a passive system, such as an NFC module, only providing functions such as information reading after approaching.

### Embodiment 2

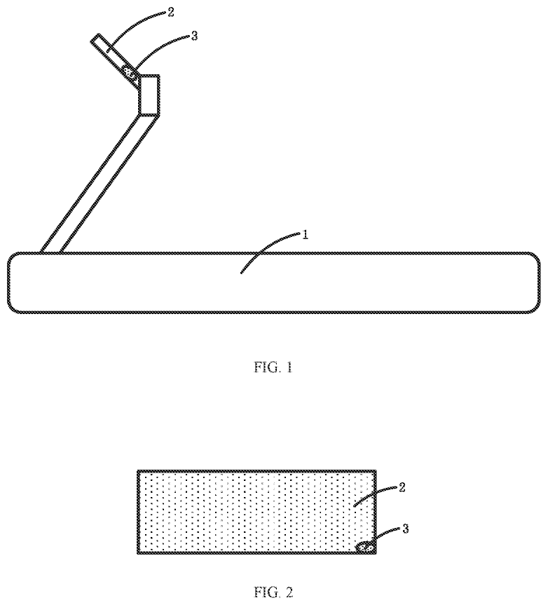

Referring to FIG. 1, in this embodiment, equipment with real-time interactive function is provided, comprising: equipment main body 1, and an interactive connection system for realizing an interactive function between the equipment main body and an external terminal.

The interactive connection system comprises a hardware subsystem and a software subsystem installed on the equipment, the hardware subsystem is used for realizing a signal intercommunication connection between the external terminal equipment main body, and the software subsystem is used for processing and sending information about the equipment main body received by the external terminal.

The hardware subsystem comprises a control processing module and an NFC module. The control processing module processes and sends movement data collected by the equipment main body, and sends an instruction. The NFC module is used for realizing the interactive connection between the control processing module and the external terminal. The control processing module is electrically signal connected to the NFC module, and the control processing module is also electrically signal connected to an interface set, and the interface set is installed on the equipment via a switching assembly.

The control processing module comprises a data collection unit, an instruction generation unit, and an information processing unit. The data collection unit is used for collecting the movement data when a user is using the equipment, the instruction generation unit generates a corresponding instruction according to an interactive connection with the external terminal, and the information processing unit is used for sending after processing the movement data collected by the equipment and the control instruction generated by the instruction generation unit.

The data collection unit is mainly used for collecting the movement data of the equipment.

For example, when a body builder uses the running machine, the data collection unit can record and collect relevant running data, and later sends the same to the intelligent terminal of the body builder via the information processing unit, and stores the same in the intelligent terminal of the body builder or the APP (connecting software) of the intelligent terminal for the body builder to view the fitness information at any time later. When the intelligent terminal of the body builder is connected to the interactive connection system of the equipment, the interactive connection system firstly detects or tries to connect via the connecting software of the intelligent terminal. If it is detected that the intelligent terminal has not installed the connecting software or fails to connect, the instruction generation unit generates software installation reminding information and the information processing unit sends the same to the intelligent terminal of the body builder, so as to remind the body builder to install the connecting software, or sends a connection failure reminding to the intelligent terminal to remind re-connection, etc.

In the present embodiment, the interface set comprises a Lightning interface, a Type-c interface, and a Micro-usb interface or other types of interfaces for realizing a wired connection between an intelligent terminal and the equipment via a data line or a signal line, etc. so as to realize more interactive functions, such as video playing, audio playing, etc.

In this embodiment, the equipment main body 1 is provided with an object placing plate 2, the surface thereof being provided with a screen or a sticker (not shown). The object placing plate 2 is generally used for a body builder to place a mobile phone, a tablet computer, a smart phone, a bracelet, or other intelligent terminals. However, the existing object placing plates 2 are all black plates, and the surfaces thereof are not used. In the present embodiment, on the one hand, a sticker for propaganda, a poster containing a motivational slogan, etc. can be sticked on the surface of the object placing plate 2, and some QR codes (not shown in the figure) can also be provided to facilitate the body builder to download a corresponding APP; on the other hand, the object placing plate 2 can also be provided a screen, which can be used for playing an advertisement, and playing audio and video when interacting with an intelligent terminal, and other scenarios, so that the object placing plate 2 can be used with multiple functions.

Referring to FIG. 2, in the present embodiment, an NFC module 3 is provided on the lower right of the surface of the object placing plate 2 for enabling the interaction with the equipment after the external terminal nears.

When the external terminal approaches the equipment's interactive connection system, the interactive connection system communicates with the external terminal. That is, when a body builder places the external terminal close to the NFC module 3 provided on the lower right of the surface of the object placing plate 2, communication and interaction can be achieved.

It will be appreciated by those skilled in the art that the interactive connection system on the equipment may be powered by an external power source on the equipment itself to provide the power source for the interaction. If the external terminal only needs to be connected and does not need to perform data communication and interaction, the interactive connection system on the equipment can be a passive system, such as an NFC module, only providing functions such as information reading after approaching. Take the example that the external power source of equipment also provides the power source for the interactive connection system to ensure that it can realize the communication and information interactive functions in addition to the information reading function.

Then, the interactive connection system can judge whether the external terminal is installed with the connecting software corresponding thereto; if not, the external terminal is enabled to display installation reminding information; if so, the external terminal is directly controlled to open a designated software interface, and the interactive connection system subsequently sends information to the connecting software to display the corresponding content.

The present embodiment also provides a using method for equipment with real-time interactive function, which is specifically as follows:
S1, the interactive connection between equipment main body 1 and a mobile phone: placing a mobile phone on an object placing plate 2, wherein the object placing plate 2 is not limited to being installed on the equipment main body 1 via a support, and can also be arranged on some bases and side walls of the equipment, etc.; with regard to a mobile phone with NFC function, NFC module 3 inducts a mobile phone end NFC so as to realize a wireless connection between the mobile phone and the equipment main body 1; with regard to a mobile phone without an NFC function, a corresponding interface can be selected to be plugged into a mobile phone socket so as to realize the wired connection between the mobile phone and the equipment main body 1; after the mobile phone is connected to the equipment main body 1, whether a corresponding APP is installed in the mobile phone is detected; if no corresponding APP is installed, then a relevant signal is sent to an instruction generation unit, the instruction generation unit generates a corresponding instruction and the same is sent to the mobile phone after being processed by an information processing unit, and the mobile phone is controlled to enter a downloading interface of the corresponding APP; if it is detected that the corresponding APP is installed in the mobile phone, the mobile phone is controlled to open the APP;
S2, automatic processing and uploading of data: during the process of the fitness of a body builder, a collection device on the equipment main body 1 collects the movement data, and transmits the same to a control processing module; the information processing unit processes the received movement data, and transmits the same to the mobile phone via an NFC or a data line; a software subsystem summarizes and classifies the received information, and the classification can be classified according to fitness types, such as running, riding, etc.; when a body builder runs via a running machine, the software subsystem summarizes the received data into a running classification; by observing the analysis, data such as when to perform a running movement, how much the running amount and the duration is, and how much the movement amount is, etc. can be understood; these data is, after being classified and summarized, stored in an APP on the mobile phone end, and the body builder can call for viewing at any time.

In addition, after the mobile phone of the body builder has interacted with the equipment, the body builder may later remotely connect the equipment by opening the APP via the mobile phone to effect some operation or control of the equipment.

### Embodiment 3

In this embodiment, a using method for equipment with real-time interactive function is proposed. When an external terminal approaches an interactive connection system of the equipment, the interactive connection system communicates with the external terminal and directly controls the external terminal to open a designated software interface.

In the present embodiment, firstly, the equipment end is provided with an interactive connection system, for example, an NFC module or other systems which can ensure connection and interaction, and the NFC module is taken as an example herein; secondly, the external terminal also has the communication module, for example, a smart phone with NFC function; when the smart phone approaches the NFC module of the equipment, and when the smart phone has downloaded the APP used for the equipment connection, the smart phone can be enabled to directly open the main interface of the APP, without requiring the body builder to open the mobile phone again to search for the APP, and open the APP, thereby directly saving the body builder from a cumbersome APP opening procedure. It only requires approaching the corresponding equipment such that the corresponding APP interface can be opened directly, which is convenient and quick.

### Embodiment 4

The embodiment also proposes another using method for equipment with real-time interactive function. When an external terminal approaches an interactive connection system of the equipment, the interactive connection system communicates with the external terminal, and directly enables the external terminal to realize a Bluetooth automatic pairing connection with the equipment.

Like embodiment 3, the equipment needs to be provided with an interactive connection system, for example, an NFC module or other systems which can ensure connection and interaction, and likewise the NFC module is taken as an example; the external terminal also needs to have a Bluetooth function. In this way, there is no need for a body builder to manually identify the equipment via Bluetooth, and manually achieve a pairing connection, thereby saving time and being convenient and quick.

Furthermore, the embodiment can also be combined with embodiment 3. Namely, when a mobile phone approaches the NFC module of the equipment, a corresponding APP interface can be automatically opened, and the Bluetooths of the two can be ensured to be automatically matched and connected so that data transmission and related control operations can be performed via the Bluetooth.

A smart phone is taken as an external terminal as another example, and an NFC module is provided on an object placing plate of the equipment, for example, providing the NFC module on a side face, a back face, or a front face, etc. and providing an NFC sign or other conspicuous signs; when a body builder brings the smart phone close to the NFC module of the object placing plate, if the smart phone interacts with the equipment for the first time, and the smart phone is not installed with a corresponding APP, a corresponding APP downloading reminder is displayed on the smart phone end; the body builder may download the APP first and then continue to connect to the equipment, and at this time the smart phone interacts with the equipment. When later on a connection is made again, the connection can be made automatically only when the NFC module is neared, for example, a Bluetooth matching connection can be realized.

After the connection, the body builder can perform corresponding exercises, and the movement data of the equipment will be collected via the interactive connection system, and sent to the APP of the smart phone end via Bluetooth for display, and stored in the APP for the body builder to refer to later on.

In addition, if the equipment comprises a display screen, etc., the body builder can also play the audio and video of the smart phone end on the equipment via the interactive connection system.

It will be understood by those skilled in the art that the external terminal may be an intelligent terminal such as a smart watch, a bracelet, a Bluetooth headset, or a tablet computer, and is not limited to a smart phone. The equipment may be a running machine, a mountain climbing machine, a spin bike, etc. The movement data includes running, riding, etc. which allows the body builder to know the data of when to perform running movement, the duration of the running amount, and the amount of movement, etc. Of course, other equipment and corresponding movement data may be used apart from this.

While the preferred embodiments of the equipment with real-time interactive function have been set forth above in order to clearly illustrate the content of the present invention, it should be clearly pointed out that the content of the present invention is not limited to the following embodiments and that other modifications, which made by those of ordinary skills in the art with conventional technical means, are also within the spirit and scope of the present invention.

In view of the above, the beneficial effects of the present invention are mainly represented as follows: the equipment is provided with an interactive connection system; the external terminal can be connected to the equipment via the interactive connection system, and directly controls the external terminal to open a designated software interface, or directly enables the external terminal to realize a Bluetooth automatic pairing connection with the equipment, thereby reducing the cumbersome procedure of manually opening an APP and the cumbersome procedure of manually connecting Bluetooth, and saving time, making it convenient and quick.

Furthermore, the movement information on the equipment can be obtained through the above-mentioned connection and interaction, and the relevant information can be obtained through a simple and quick connection for subsequent information processing and displaying.

The interactive connection system includes a hardware subsystem and a software subsystem.

The external terminal can realize the near-field connection through NFC, and can also realize the remote connection through the connecting software installed by the external terminal.

After the external terminal is connected with the interactive connection system, the interactive connection system can send the collected equipment movement information to the external terminal, and display the same via the connecting software, so as to display relevant information about the exercise using the equipment to the body builder to facilitate the body builder to have a clearer understanding of the movement status thereof, and facilitate the body builder to arrange for fitness via statistical induction and summary.

Obviously, those skilled in the art can make various changes and variations to the present invention without departing from the spirit and scope of the present invention. In this way, if these modifications and variations of the present invention fall within the scope of the claims of the present invention and their equivalent technologies, the present invention is also intended to include these changes and variations.

1. Equipment with real-time interactive function, characterized by comprising: equipment main body and an interactive connection system, wherein the interactive connection system is arranged on the equipment main body, and an external terminal is connected to the equipment main body via the interactive connection system.

2. The equipment with real-time interactive function according to claim 1, characterized in that the external terminal approaches or nears the interactive connection system on the equipment main body to realize a near-field connection.

3. The equipment with real-time interactive function according to claim 2, characterized in that the near-field connection is realized via NFC.

4. The equipment with real-time interactive function according to claim 1, characterized in that the external terminal is remotely connected to the interactive connection system on the equipment main body via connecting software.

5. The equipment with real-time interactive function according to claim 4, characterized in that a remote connection is realized by Bluetooth, mobile communication, WiFi, or infrared communication.

6. Equipment with real-time interactive function, characterized by comprising: equipment main body, an interactive connection system for realizing the interactive function between the equipment main body and an external terminal, wherein the interactive connection system comprises a hardware subsystem and a software subsystem installed on the equipment main body, the hardware subsystem is used for realizing a signal intercommunication connection between the external terminal and equipment main body, and the software subsystem is used for processing and sending information about the equipment main body received by the external terminal.

7. The equipment with real-time interactive function according to claim 6, characterized in that the hardware subsystem comprises a control processing module and an NFC module, wherein the control processing module processes and sends movement data collected by the equipment main body, and sends an instruction, the NFC module is used for realizing the interactive connection between the control processing module and the external terminal, the control processing module is electrically signal connected to the NFC module, the control processing module is also electrically signal connected to an interface set, and the interface set is installed on the equipment main body via a switching assembly.

8. The equipment with real-time interactive function according to claim 7, characterized in that the control processing module comprises a data collection unit, an instruction generation unit, and an information processing unit, wherein the data collection unit is used for collecting the movement data when a user is using the equipment main body, the instruction generation unit generates a corresponding instruction according to the interactive connection with the external terminal, and the information processing unit is used for sending after processing the movement data collected by the equipment main body and a control instruction generated by the instruction generation unit.

9. The equipment with real-time interactive function according to claim 6, characterized in that the equipment main body is provided with an object placing plate, a surface thereof being provided with a screen or a sticker.

10. A using method for equipment with real-time interactive function, characterized in that when an external terminal approaches an interactive connection system of the equipment main body, the interactive connection system communicates with the external terminal, and judges whether the external terminal is installed with connecting software corresponding thereto; if not, the external terminal is enabled to display installation reminding information; if so, the external terminal is directly controlled to open a designated software interface, and the interactive connection system subsequently sends information to the connecting software to display corresponding contents.

11. (canceled)

12. (canceled)
